(19) United States
(12) Patent Application Publication
(10) Pub. No.: US 2009/0002161 A1
(43) Pub. Date: Jan. 1, 2009

(54) Security System for Motorcycle Crash Helmet

(76) Inventor: Massimiliano Luciani, Cologno Monzese (IT)

Correspondence Address: HARNESS, DICKEY & PIERCE, P.L.C., P.O. BOX 8910, RESTON, VA, 20195, US

(21) Appl. No.: 11/579,110

(22) PCT Filed: May 9, 2005
(86) PCT No.: PCT/IT2005/000269

§ 371 Date: Aug. 26, 2008

(30) Foreign Application Priority Data
May 19, 2004 (IT) MI2004A001001

(51) Int. Cl. G08B 13/14

(52) U.S. Cl. 340/568.6

(57) ABSTRACT

Security system for the crash helmet (1) of a motorcycle (100), comprising a security system (10) installed into the crash helmet (1) which communicates through radio waves (wireless with the control device comprises a normally open switch (T2) placed between the power supply (120) and the ignition system (121) of the motorcycle, and driven by a wireless communication device (119) which communicates with a wireless communication device (19) installed into the crash helmet security device (10). The security device (10) comprises detection means (15, 5, 13, 14) suited to detect the crash helmet use by the user and, accordingly, to send a command signal in order to enable the crash helmet communication system (19) to communicate with the motorcycle communication system (119), to close the switch (T2) and allow the motorcycle ignition.

The present invention refers to a security system for motorcycle crash helmet. As known, the current regulations for traffic security enforce the obligation to wear a crash helmet during the use of a motorcycle. However, many motorcycle drivers continue to infringe such regulations and do not wear any crash helmet during motorcycle riding.

Other regulations enforce the prohibition for a motorcycle driver to use cellular phones. In this case also many motorcycle drivers infringe such regulations and they use cellular phones also during the travel.

Other drawbacks for users are the several thefts both of crash helmets and motorcycles.

An object of the present invention is to eliminate the drawbacks of the prior art by providing a security system for a motorcycle crash helmet which enforces the use of a crash helmet during motorcycle riding.

Another object of the present invention is to provide a security system for a motorcycle crash helmet which replaces the cellular phone, in order to allow the user to listen and answer safely to the calls on his own cellular phone.

Another object of the present invention is to provide a security system for motorcycle crash helmets which also works as an antitheft device, in order to avoid both the theft of the crash helmet and of the motorcycle.

These objects are reached according to the invention with the characteristics listed in the enclosed independent claim 1.

Advantageous embodiments of the invention are disclosed in dependent claims.

The security system for motorcycle crash helmets according to the invention includes a security device installed in the crash helmet and a control device installed in the motorcycle. The security and control devices communicate through radio waves (namely wireless).

The control device comprises a normally open switch, placed between the power supply and the ignition system of the motorcycle. Such a switch is driven by a wireless communication device which communicates with a wireless communication device installed into the crash helmet security device.

The security device comprises detection means suited to detect the crash helmet use by the user and, accordingly, to send a command signal in order to enable said crash helmet communication system to communicate with the motorcycle communication system, to close the control device switch and allow the motorcycle ignition.

In this way the motorcycle can be ignited only when the detection means detect that the crash helmet is worn by the user.

Further characteristics of the invention will became more clear from the following detailed description shown in the drawings enclosed, which refers to a merely exemplary form and is not intended as a limiting embodiment, in which:

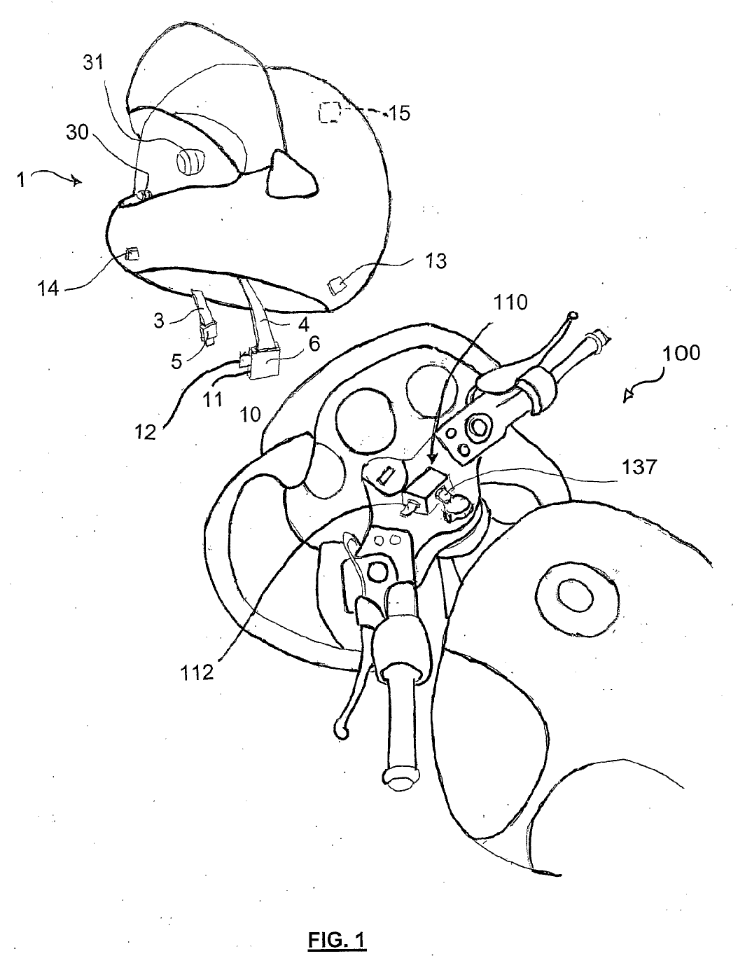

FIG. 1 is a partial perspective view showing a crash helmet and a motorcycle, in which the security system according to the invention is installed;

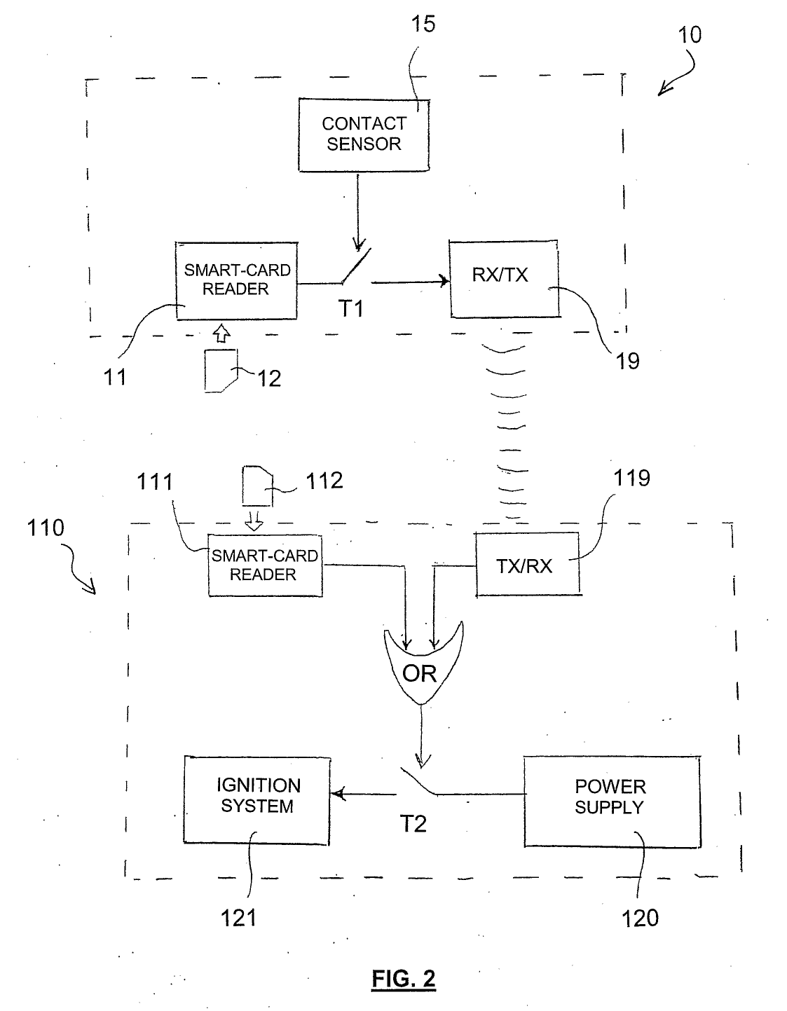

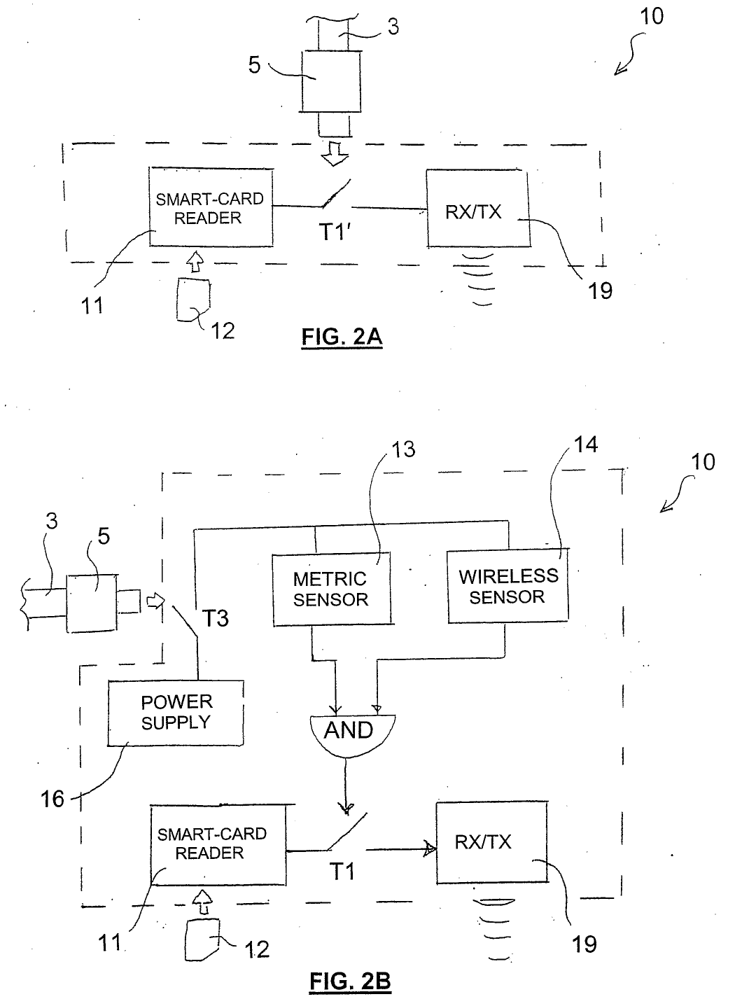

FIG. 2 is a block diagram showing the security system according to the invention;

FIG. 2A is a first embodiment of the crash helmet security system according to the invention;

FIG. 2B is a second embodiment of the crash helmet security system according to the invention; and

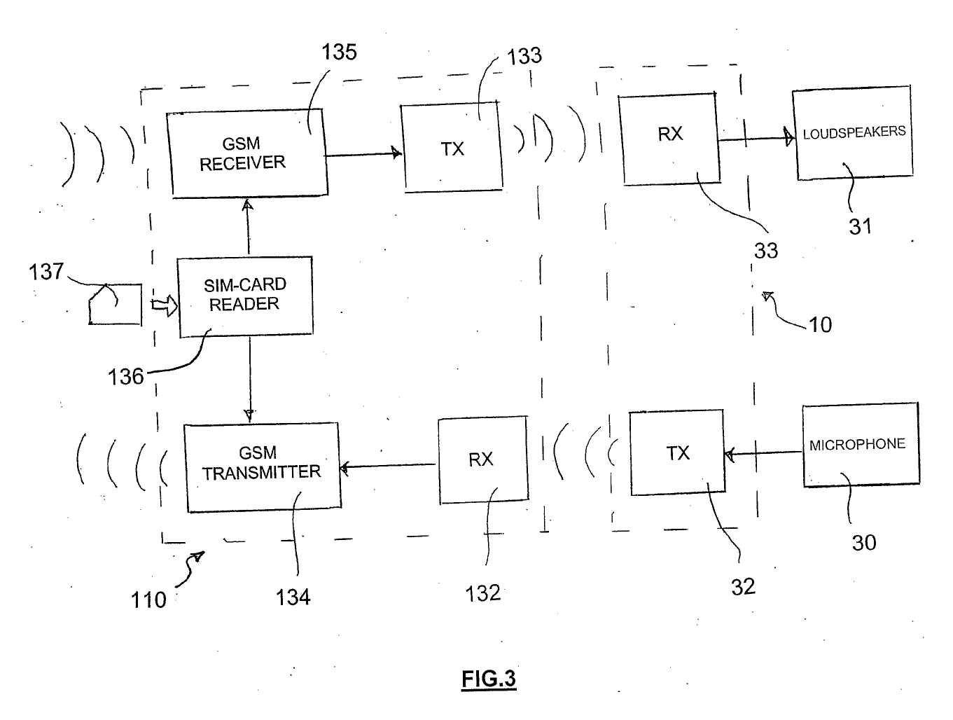

FIG. 3 is a block diagram showing the operation of the security system according to the invention in its function of cellular phone.

In FIG. 1 a crash helmet, marked as a whole by the reference number 1, is shown. From the lower edge of the crash helmet 1, two length adjustable strips 3, 4 protrude, respectively ending in a clasp 5 and in a locking block 6 in which the clasp 5 snaps. In this way, strips 3, 4 pass under the user chin, holding the crash helmet in position.

Into the locking block 6, a security device 10 which will be described in further detail with reference to FIGS. 2, 2A, 2B and 3 is integrated. Clearly, the security device 10 can alternatively be integrated in another portion of the crash helmet.

Referring now to FIGS. 1 and 2, the security device 10 comprises a smart-card reader 11 suited to read a smart-card 12 in which a secret code is codified. The smart-card 12 is supplied to the owner of the crash helmet 1 by the motorcycle manufacturer who sells the motorcycle 100 to the owner of the crash helmet 1.

Into the motorcycle 100, a control device 110 suited to communicate with the security device 10 of crash helmet 1, is installed, as will be described in further detail with reference to FIGS. 2 and 3. As such, the control device 110 recognizes the code of the smart-card 12 inserted into the reader 11 of security device 10. For example, as shown in FIG. 1, the control device 110 can be installed on the central upper portion of the handlebar of the motorcycle 100.

Turning back to FIG. 2, the control device 110 provides a normally open switch T2 which interrupts communication between the motorcycle power supply 120 and the motorcycle ignition system 121.

The smart-card reader 11 of the security device 10 is connected, through a normally open switch T1, to a passive communication device 19, such as a passive transceiver. The passive communication device 19 of the crash helmet security device is coupled to communicate, through radio waves (wireless), with an active communication system 119, such as an active transceiver, installed into the motorcycle control device 110.

Switch T1 of the security device is driven by a contact sensor 15 placed within the crash helmet 1. Upon detecting the user head inside the crash helmet 1, the contact sensor 15 sends a command signal to switch T1, which closes, putting the smart-card reader 11 and the passive transceiver 19 into communication.

In this way, when the switch T1 is closed, the active transceiver 119 reads and recognizes the code of the smart-card 12 through the passive transceiver 19. Once the code is recognized, the active transceiver 119 sends a command signal to switch T2, which closes allowing the motorcycle ignition. As a result, with the system according to the invention, the motorcycle ignition is impossible unless the user wears the crash helmet.

For greater safety, to avoid that the motorcycle 100 remains ignited even when the user wearing the crash helmet is far from the motorcycle, for example in case of accident, the two wireless communication devices 19, 119 are arranged to communicate only within a short range, e.g. a distance lower than 2 meters. Therefore, when the user wearing the crash helmet is farther than 2 meters from the motorcycle 100, the active communication device 119 can not read the code of the smart-card 12 and so switch T2 opens, causing the motorcycle to switch off.

In this way the crash helmet 1 also functions as an antitheft device for motorcycle 100. As a matter of fact, the motorcycle 100 can not be ignited unless the user wears the crash helmet 1 with its related smart-card 12.

If the user looses the smart-card 12 of the crash helmet security device or the crash helmet is stolen, the control device 110 is provided also with a smart-card reader 111 suited to read a reserve smart-card 112, which matches the smart-card 12 of the crash helmet security device. In this way the smart-card reader 111, when reading the reserve smart-card 112, bypasses transceiver 119 and closes switch T2 to allow the motorcycle ignition. For example, the output signal of the active transceiver 119 and the output signal of the smart-card reader 111 can be sent to a logic OR whose output commands switch T2.

In a first modification of security system 10, as shown in FIG. 2A, instead of or in addition to the contact sensor 15, a normally open mechanical snap switch T1′, placed within the locking block 6 of clasp 5, can be provided. The switch T1′ closes when clasp 5 snaps into the locking block 6, putting the smart-card reader 11 and the passive transceiver 19 into contact.

In order to avoid that clasp 5 is inserted into the locking block 6 when the user does not wear the crash helmet, a second modification of the security device 10 is implemented, as shown in FIG. 2B.

In this case, a first metric type sensor 13, suited to detect the crash helmet distance from the ground, and a second radio wave type sensor 14, suited to communicate with the control device 110 of motorcycle 100 in order to detect the crash helmet distance from motorcycle 100, are installed into the crash helmet 1 (FIG. 1). The metric sensor 13 is set to send a command signal when it is at a distance greater than 1.5 meters from the ground, and the wireless sensor 14 is set to send a command signal when it is at a distance lower than 2 meters from the motorcycle.

With reference to FIG. 2B, the security device 10 comprises a power supply 16 which, through a normally open mechanical switch T3, is connected to a power supply line that supplies the two sensors 13 and 14. The two sensors outputs are connected to a logic AND whose output controls switch T1, which puts the smart-card reader 11 and the passive communication device 19 into communication.

As a result, the active communication device 119 reads the code of the smart-card 12, through the passive communication device 19, only when the crash helmet in fastened, it is at a distance greater than 1.5 meters from the ground, and it is at a distance lower than 2 meters from the motorcycle 100.

The function of the ground distance sensor 13 is to avoid the use of motorcycle 100 if the fastened crash helmet is placed on the handlebar and not worn. On the other hand, the function of the motorcycle distance sensor 14 it to assure that the motorcycle switches off if the user wearing the crash helmet is far from the motorcycle, for example in case of accident.

Optionally, as shown in FIG. 1, a microphone 30, placed within the chin rest, in register with the user's mouth, and a couple of loudspeakers 31 (only one visible in FIG. 1), placed within the crash helmet into the side walls, in register with the user's ears, are installed into the crash helmet 1.

As shown in FIG. 3, the microphone 30 is connected to a wireless transmitter 32 and the loudspeakers 31 are connected to a wireless receiver 33. The wireless transmitter 32 and receiver 33 are integrated into the security device 10 of crash helmet 1 and are coupled into communication with a wireless receiver 132 and a wireless transmitter 133, respectively, installed within the control device 110 of motorcycle 100.

The wireless receiver 132 and wireless transmitter 133 are connected to a GSM transmitter 134 and a GSM receiver 135, respectively, also installed within the control device 110 of motorcycle 100. In this case, also a SIM-card reader 136, suited to read a telephone SIM-card 137, is integrated into control device 110. The SIM-card reader 136 is connected to the GSM transmitter 134 and to the GSM receiver 135.

In this way, the user can put the telephone SIM-card 137 of his own cellular phone into the corresponding reader 136. Therefore, when he receives a call at his own SIM-card number, the GSM transmitter 134 and the GSM receiver 135 are enabled and, through the wireless transmitters and receivers 132, 32 and 133, 33, communicate with the microphone 30 and the loudspeakers 31 provided in the crash helmet 1. In this way the user can listen and answer to calls during travel, keeping his hands on the handlebar.

It is to be noted that the security system 10 can provide a power supply 16 (FIG. 2B) which, apart from supplying sensors 13 and 14, can supply also the contact sensor 15, the smart-card reader 11 and the communication device 19. The power supply 16 can be a disposable battery, a rechargeable battery or, preferably, a storage battery connected to photovoltaic cells placed on the crash helmet 1.

In case of rechargeable batteries, their recharging can be performed, by way of the motorcycle power supply, connecting the security device 10 to the control device 110 when the motorcycle 100 is not in use.

As further security system, into the control device 110 can be provided a tilt sensor, connected to a timer, in order to detect if the motorcycle lays on the ground for a given time period, e.g. because of an accident. Said timer can be in turn connected to the switch T2, to which, after a predetermined time period, it sends a signal to allow said switch T2 to open and, consequently, the motorcycle 100 to switch off. The timer can be also connected to the GSM transmitter 134 in order to generate an alarm signal.

It can also be contemplated that the system, through the GSM transmitter 234, could make a telephone call with a registered message to the motorcycle owner in case of theft or, in case of an accident, which is detected for example through the tilt sensor, it could generate a call that the user, if conscious, can use to ask for help and report his position.

It is also possible to equip the crash helmet of the present invention so as to allow it to receive by radio the signals from an MP3 reader or other music reader.

Many modifications and changes can be done to the present embodiments of the invention by one skilled in the art, which changes are still within the scope of the invention as defined by the appended claims.

1. Security system for the crash helmet (1) of a motorcycle (100), characterized in that it comprises a security system (10) installed into the crash helmet (1) which communicates through radio waves (wireless) with the control device (110) installed in the motorcycle (100), said control device (110) comprising a normally open switch (T2) placed between the power supply (120) and the ignition system (121) of the motorcycle, and being driven by a wireless communication device (119) which communicates with a wireless communication device (19) installed into said crash helmet security device (10), said security device (10) comprising detection means (15, 5, 13, 14) suited to detect the crash helmet use by the user and, accordingly, to send a command signal in order to enable said crash helmet communication system (19) to communicate with the motor-cycle communication system (119), so as to close the switch (T2) and allow the motorcycle ignition.

2. Security system according to claim 1, characterized in that said motorcycle security device (10) comprises a smart-card reader (11) connected, through a normally open switch (T1), to said crash helmet communication system (19), said smart-card reader (11) being suited to read a smart-card (12) in which a secret code is codified, and said switch (T1) being driven by said detection means (15, 5, 13, 14).

3. Security system according to claim 1, characterized in that said detection means comprise a contact sensor (15) placed within the crash helmet (1) to detect the presence of the user head into the crash helmet.

4. Security system according to claim 1, characterized in that said detection means comprise a clasp (5) inserted into a locking lock (6) to fasten the crash helmet strips (3, 4), wherein said clasp (5) actuates a mechanical switch (T1′, T3).

5. Security system according to claim 1, characterized in that said detection means comprise a metric sensor (13) placed in the outside of the crash helmet (1) to detect the distance of the crash helmet from the ground.

6. Security system according to claim 1, characterized in that said detection means comprise a wireless sensor (14) placed in the outside of the crash helmet (1) and communicating with a transmitter installed in the motorcycle (100) in order to detect the distance of the crash helmet from the motorcycle (100).

7. Security system according to claim 2, characterized in that said motorcycle control device (110) comprises a smart-card reader (111) suited to read a reserve smart-card (112) in order to enable the motorcycle ignition without the smart-card (12) being into the reader (11) of the crash helmet security device.

8. Security system according to claim 1, characterized in that said crash helmet communication device (19) is passive and said motorcycle communication device (119) is active.

9. Security system according to claim 1, characterized in that said crash helmet communication device (19) and said motorcycle communication device (119) are arranged to communicate within distances lower than 2 meters.

10. Security system according to claim 1, characterized in that it provides a tilt sensor within said control device (110), such a tilt sensor being suited, in cooperation with a timer, to evaluate whether the motorcycle lays on the ground more than a predetermined period of time.

11. Security system according to claim 1, characterized in that said crash helmet is equipped to receive signals by radio from a music reader.

12. Security system according to claim 1, characterized in that said motorcycle control device (110) comprises:
a GSM transceiver (134, 135) enabled by a SIMcard reader (136) by means of a telephone SIM-card (137), and
a wireless transceiver (132, 133) connected to said GSM transceiver (134, 135) and communicating, by means of radio waves, with a wireless transceiver (32, 33) installed into said crash helmet security device (10) and connected to a microphone (30) and to two loudspeakers (31) mounted into the crash helmet (1).
